(19) United States
(12) Patent Application Publication
(10) Pub. No.: US 2007/0149113 A1
(43) Pub. Date: Jun. 28, 2007

(54) Signal presence detection

(76) Inventor: David K. Fitzrandolph, Phoenix, AZ (US)

Correspondence Address: MOTOROLA, INC., 1303 EAST ALGONQUIN ROAD, IL01/3RD, SCHAUMBURG, IL, 60196, US

(21) Appl. No.: 11/319,316

(22) Filed: Dec. 28, 2005

(51) Int. Cl. H04H 7/00

(52) U.S. Cl. 455/3.06

(57) ABSTRACT

A signal receiver where the presence of a signal is determined by integrating the magnitude of the signal, and determining the value of the slope of the integrator output as a function of integration time. The slope value is compared with a first threshold value corresponding to the presence of a signal of desired power at the input to the integrator. A signal may be considered present if the slope value exceeds the first voltage value. In addition, the integrated signal is compared with a second threshold value, and a second determination of the presence of a signal is made. The first determination may be used as the sole indicator of the presence of a signal, or the first and second determinations may be combined in an AND gate to be used as an indication of signal presence.

### TECHNICAL FIELD

This application may relate to signal detection in noise, and in particular to detection of a signal received by a radio receiver.

### BACKGROUND

Determination that a signal of sufficient amplitude is present at the input to a radio receiver, which results in a signal output at baseband suitable for further processing, may prevent the output of spurious data from a demodulator or other signal processing step. When the signal is weak, a long integration time may be necessary to achieve a reliable result. The accumulation time for the integration is usually longer than a data symbol period. Since the actual data content is not usually known a priori, and thus phase shifting and amplitude modulation arising from the modulation of the signal cannot be removed, incoherent detection schemes are used.

Some receivers use in-phase (I) and quadrature (Q) local oscillator signals as part of the signal processing in order to translate the received signal to a desired frequency for further signal processing. These techniques may be used in superheterodyne or homodyne receivers. For purposes of detecting the weak signals, the I and Q components may be converted into a signal magnitude by a square-root-of-the-sum-of-the-squares (RSS) process or one of the known numerical methods of approximating such a conversion. In an alternative, the square of the magnitude of the signal, representing signal power, may be used. The incoherent integration process results in an output signal which monotonically increases with time, and a long time period may be required to reach a value sufficient to estimate that a signal is present.

In the case of direct-sequence-spread-spectrum (DSSS) transmissions, the desired signal may de-spread prior to being integrated. Examples of such systems using DSSS include personal communications systems (PCS) and the global positioning system (GPS).

When only noise is present, and where noise may include co-channel interference from other users, or from side lobes of the direct sequence demodulation process for other sequences, there is a non-zero output from the demodulator due to noise alone, as the I and Q signals have been converted to a signal magnitude. Thus, even for noise alone, the output of the integrator increases monotonically with time. One also may have the situation of very low noise, or a threshold signal where the output remains constant when the signal is below a threshold, but the output does not decrease.

For a sufficiently long integration time, the integrated output for noise alone may increase sufficiently to exceed a preset amplitude threshold and falsely indicate the presence of a signal. In some applications, such as in a GPS receiver, this could cause the subsequent processing steps and algorithmic manipulation of the data to accept and use an invalid data value, which could result in gross position errors in the radio location process, or the perception of a noise burst in a communication system. Such false indications of signal presence may be reduced by increasing the preset amplitude threshold, however, this necessarily decreases the receiver sensitivity to weak signals. Accordingly, there is a need for a method and apparatus for determining the presence of a signal even when the signal is very weak or even in the presence of noise.

### BRIEF DESCRIPTION OF THE DRAWINGS

Embodiments of the inventive aspects of this disclosure is best understood with reference to the following detailed description, when read in conjunction with the accompanying drawings, in which:

FIG. 1 is a block diagram of a receiver front end providing I and Q signal outputs;

FIG. 2 is a block diagram of a signal presence determination circuit in a DSSS receiver;

FIG. 3 illustrates the time dependence of the signal magnitude at the output of the integrate-and-dump circuit;

FIG. 4 illustrates the time dependence of the slope of the signal magnitude at the output of the integrate-and-dump circuit; and

FIG. 5 is a block diagram of a signal presence determination circuit in a DSSS receiver where both the signal magnitude and the signal magnitude slope at the output of the integrator are used to determine the signal presence.

### DETAILED DESCRIPTION

Exemplary embodiments may be better understood with reference to the drawings, but these examples are not intended to be of a limiting nature. Like numbered elements in the same or different drawings perform equivalent functions.

The processing of a received signal may be by either analog or digital circuits, or a combination thereof. The signal processing may be also performed by one or more computers with associated memory and computer code which performs mathematical operations and functions equivalent to those performed by the analog or digital circuits. Herein, there is not intended to be a restriction of the type of circuit which performs each function or groups of functions, or the combination of types of circuits which may be used, although the examples may mention a specific type of circuit in the description thereof.

In an aspect where a computer or a digital circuit is used, the received signal may be converted from an analog format to a digital representation thereof in an analog-to-digital (A/D) converter, as is known in the art. The A/D conversion process may be performed at any location in the system after reception of a signal by the antenna. The choice of location of the A/D conversion depends on the specific application and design. Where a received signal has been converted from analog to digital form, the signal representation may be described in terms of a digital word, or as the signal amplitude, voltage, or other physical measure of the value of the signal which would be appropriate in the case of the analog signal, without suggesting that the information is necessarily in analog or digital format. Similarly, digital data may be converted to analog format in a digital-to-analog (D/A) converter.

A signal receiver is disclosed, including a first circuit configured to accept an input from a demodulator output, to integrate the input, to determine a value of the integrated input and a value of a slope of the integrated input, and to compare the value of the slope with a first threshold value. When the value of the slope exceeds the first or slope threshold, a detection value is output. The integrated input may also be compared with a second or signal threshold value, and a detection value output if both the first and the second detection thresholds are simultaneously exceeded.

A method of detecting the presence of a signal is also disclosed, the method including the steps of integrating the signal in a first integrator for a first time period and outputting the integrated result into a second integrator; integrating the first integrator output in the second integrator for a second time period, the second time period being longer than the first time period; processing an output of the second integrator during the second time period to determine a slope of the second integrator output; and, comparing the slope with a first threshold value.

In an example of a receiver, portions of which are shown in FIG. 1, which may include a DSSS receiver and be used in a GPS or communications application, the signal received by the antenna 10 may be processed in a radio frequency (RF) module 12 and multiplied in mixers 14 a, b by a local oscillator signal 16, which has been divided into two signals 18 a, b having a 90° phase relationship with each other. The output of the mixer may be at baseband (zero center frequency), where the received signal has been separated into I and Q signal components. The RF module 12 may include filters, amplifiers, mixers and local oscillators as are known in the art. The signal may be downconverted to one or more intermediate frequencies by local oscillators prior to further processing.

The data signal is recovered by known signal processing techniques which may synchronize a pseudo-random code sequence (sometimes called pseudo-random-noise (PRN)) which is a duplicate copy of the pseudo-random code sequence emitted by the transmitter, corresponding to the channel intended to be received by the receiver. Often this duplicate PRN code is called a replica PRN code. However, in the case of the transmitted signal, the PRN may also be modulated by another signal which contains information to be transmitted. In the case of GPS, for example, there may be up to 32 possible channels occupying the same center frequency, and the GPS receiver selects the desired channels by correlating the received signal with the appropriate replica PRN code. A PRN code sequence may consist of a sequence of time intervals or “chips” where, during each time interval, the phase of the transmitted signal has a known relationship to the signal transmitted in the previous time interval. Each chip may represent one element of the PRN code, where the code may have a plurality of chips, and the PRN code may be repeatedly transmitted. The duration of a single repetition of the PRN code may be termed a PRN period.

Where the DSSS signal is used both to transmit data as well as being used for position location by ranging measurements to the satellites, such as in GPS, the relative time offset between each PRN code, which is uniquely associated with a satellite, and replica PRN at the receiver which is used as a reference in the demodulation process, is also of interest. For the purposes of determination of signal presence, however, it is sufficient to recognize that the synchronization of the replica PRN code with received signal PRN code permits the data signal to be recovered.

The time correspondence between the received signal PRN code and the receiver replica PRN code is initially unknown, and the starting time of the receiver PRN code may be adjusted so that a correlation maximum between the received signal and the replica PRN code is obtained. This aspect of the demodulation process, which may be termed de-spreading, permits the separation of the desired received channel from other unwanted signals within the receiving bandwidth.

When the received signal has a Doppler shift, for example due to the satellite motion, a correction may be computed such that the Doppler shift may be accounted for by a change in the local oscillator 16 output frequency. Demodulation of the DSSS signal may include compensation of the Doppler shift by altering the local oscillator 16 frequency, and time synchronization between the replica PRN code and received PRN code adjusted such that a maximum output value is achieved. The data signal may then be demodulated in accordance with conventional techniques, the selected technique depending on the modulation format of the data that is part of the design of a system. Characteristics such as the data symbol length, coding scheme, error correction, and the like may be chosen separately from the spreading PRN code properties.

In the present discussion, time synchronization between the PRN sequence at the receiver and that of the signal being received may have been established. Alternatively, the synchronization may have occurred successfully, however, the signal may be weak, or synchronization may not have occurred. In at least these circumstances, it is desired to ascertain whether a signal is actually present while minimizing the probability of a false detection of signal presence.

In an aspect, the transmitted signal may be a GPS satellite transmission, on frequency L1, of what is known as the Coarse Acquisition (C/A) PRN code, where the specific PRN code is associated with one of the GPS satellites. The code type used is a 1023-chip Gold code with a chip rate of 1.023 MHz, so that the code is transmitted once every 1 msec. Data is also transmitted on this signal at a rate of 50 bits per second, so that there are 20 PRN periods during a single bit period.

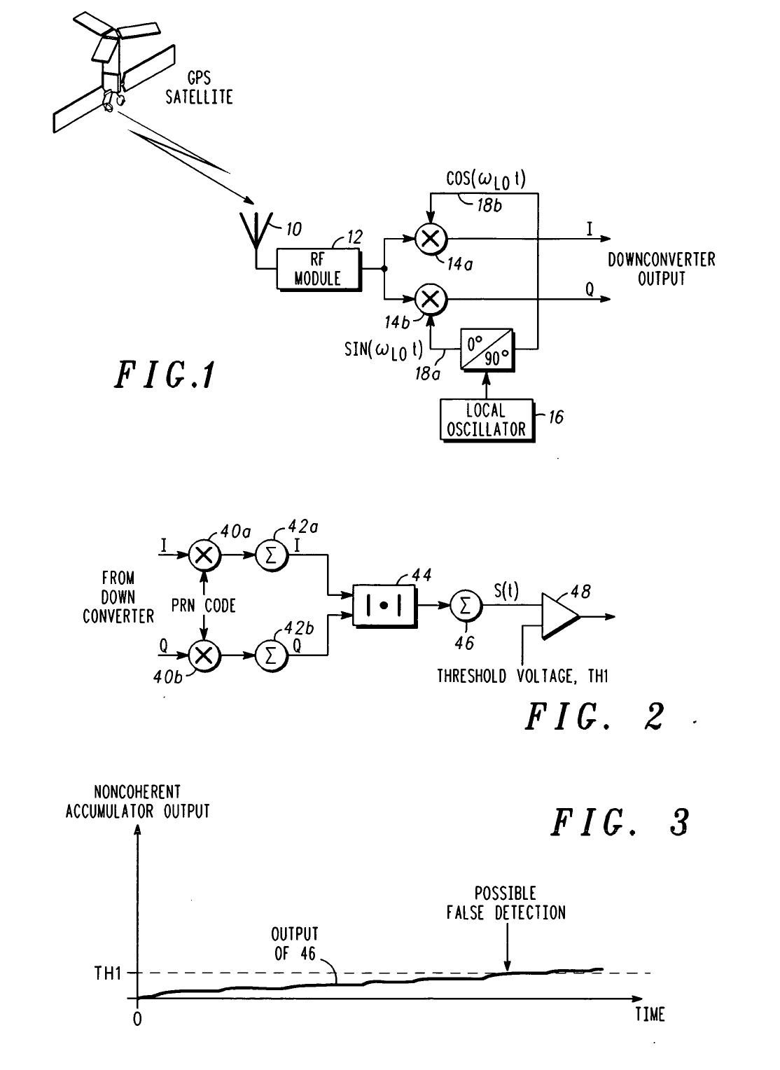

FIG. 2 illustrates the further processing of the signal after the received signal has been multiplied by the desired PRN sequence in multipliers 40 a, b to create the I and Q data by de-spreading the spread-spectrum signal. The output signals of the multipliers 40 a, b may be filtered and are input to integrate-and-dump integrators 42 a, b where the integration period is equal to one or more PRN periods, and the output of the integrators 42 a, b is set to zero at the beginning of the integration period. The integration period of integrators 42 a, b is often called the pre-detection interval (PDI) and has a time duration Ts.

Generally, in the aspect where a GPS signal is being received, the integration time Ts may be typically chosen in the range of one to about 10 PRN periods, if the time alignment of the bit edges is not known, and for longer periods if the time alignment is known. The integration period results in an output representing the amplitude of the I and Q components of the data values which were imposed on the DSSS signal at the transmitting source. As the integration time Ts may be less than a single bit time duration, more than one sample of the I and Q components may be obtained for each data bit.

The I and Q signals are converted into a magnitude signal in a magnitude converter 44, which may execute a RSS process, or an equivalent approximation to the RSS process. The output of the magnitude converter is applied to an integrator 46, which integrates the magnitude of the signal which has been output from the magnitude converter 44. The output signal of the integrator 46 may be a continuous signal S(t), being a function of elapsed time, t, from the start of the integrator 46, t=0. After a period of time, T, has elapsed, S(t) is set to zero and the process repeats. Alternatively, the output signal S(nTs) may be a sample of the output of the integrator 46 obtained at time intervals Ts or greater, where n represents the nth sample of the output signal at an interval, Ts, since the time when the integrator 46 output signal has been set to zero at the end of the time T. For convenience, S(nTs) is represented by S(n). Ts may also be considered to represent a time, usually greater than the PDI where, in a digital system, the output of integrator 46 is transferred to other circuits for further processing. As described, the integrator 46 acts as an integrate-and dump circuit with the integrated output available either continuously or at sampled intervals during the integration, however, it is termed herein an integrator to differentiate this circuit from integrate-and-dump circuits 42, which may be similar or identical in construction and operation. Generally, S(t) and S(n) are used interchangeably as representing the continuous and discrete-time forms of the data series.

The integrator 46 output signal is compared with a threshold signal TH₁ in a comparator 48 to form a first aspect of the determination of the presence of a signal. Providing that S(n) or S(t) exceeds the threshold TH₁, a signal may be considered to be present in accordance with the first aspect of the determination of the presence of a signal.

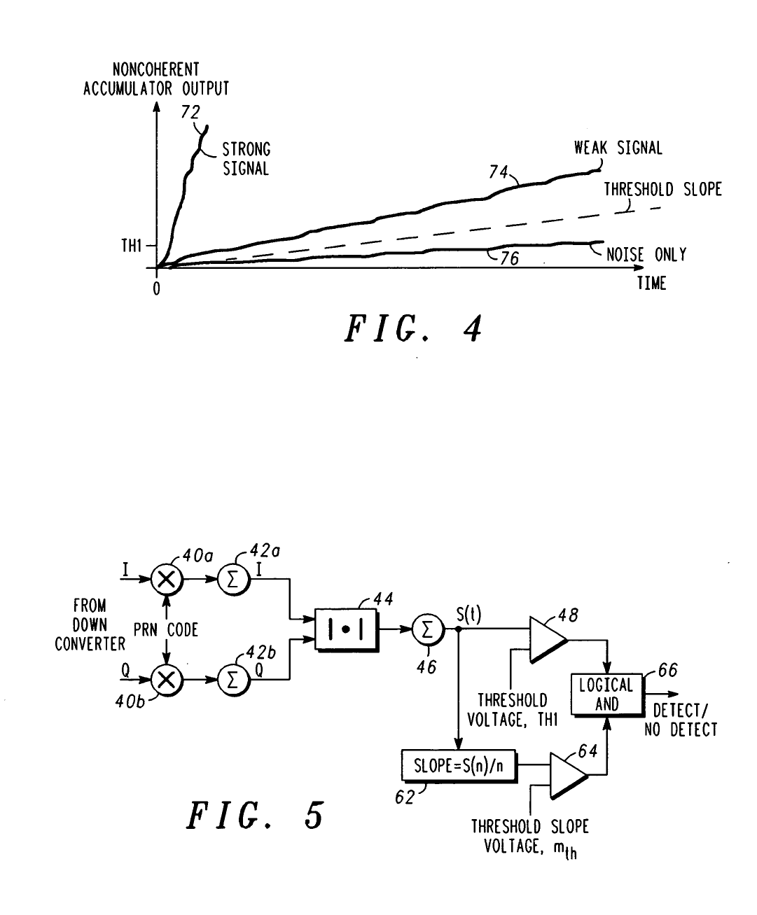

As the magnitude of the output signal derived from the I and Q channels may be non-zero due solely to the presence of noise, and where the noise may be random noise, interference, or code leakage, the value of S(n) or S(t) may increase with time such that, for a sufficiently long time, the threshold TH₁ is exceeded. This situation is shown in FIG. 3. In some examples, this processing is performed in a digital circuit, and the abscissa of FIG. 3 may be labeled so as to indicate a situation where the time base is in multiples n of the time interval Ts.

When the output signal of the integrator 46 is compared for differing values of a desired input signal, as in FIG. 4, the slope S(n)/n of the integrator 46 output signal, S(n), with respect to time or number of sampling periods, nTs, is proportional to the input signal amplitude. For large signal amplitudes 72, the slope of the integrator 46 output signal is greater than the slope of the integrator output signal for a weak signal 74. The slope 74 of the integrator 46 output for a weak signal is greater than the slope of the integrator 46 output signal when no input signal 76 is present. As such, for a desired probability of detection with a specified false detection rate, a slope m_{TH} may be established as a value which separates the regime where an input signal is considered to be present from one where the input signal is considered to be absent, and this may be termed a second aspect of the determination of the presence of a signal.

This discussion has been simplified by considering that the signal received by the receiver has a constant value. In practice, the input signal may have a value that varies with time due to a number of external factors, such as propagation conditions, multipath, blockage or shadowing, polarization fading, and the like.

In the case of digital processing of the signal S(n), the slope may be computed as the ratio S(n)/n, where n is the number of sample periods Ts of the integrator 46 since the last time that the integrator 46 was reset. The duration of a sample period Ts may correspond to the duration of one or more PRN periods. A signal is considered present for the purpose of this test if the computed slope S(n)/n is greater than a predetermined slope m_{TH}.

FIG. 5 is a block diagram of the signal presence detection portion of the receiver corresponding to that shown in of FIG. 2, where a slope measurement capability has been incorporated. A slope determination circuit 64 is connected to the output of the integrator 46 to receive the same signal S(n) as is input to the comparator 48. The signal S(n) output from the integrator 46 is compared with a threshold value TH₁ in the comparator 48. A first aspect of signal presence determination occurs when the value of S(n) is greater than the value TH₁.

The output signal from the slope determination circuit 64 is applied as one of the inputs to a comparator 64, where the other input is a value, m_{TH}, related to the a desired threshold slope. The value, m_{TH}, is established based on the desired sensitivity and false alarm rate of the receiver. The slope S(n)/n computed by the circuit 62 is compared with the predetermined slope m_{TH} in a comparator 64. The output of the comparator 64 forms a second aspect of the received signal presence determination, and is combined with the first aspect of the signal presence determination. Each of the output signals from the comparator 48 and the output signal from the comparator 64 are input to a logical AND circuit 66. The presence of signals S(n) and S(n)/n at the inputs to each of the comparators 48, 64, respectively, having magnitudes greater than the corresponding threshold values TH₁ and m_{TH} results in a signal detection indication at the output of the AND circuit 66.

The output of comparator 48 and comparator 64 are input to individual gates of an AND circuit 66, such that an output signal indicating that there is a received signal present is provided when each of the outputs of the comparators 48 and 62 indicates that a received signal is present in accordance with the first and second aspects of signal presence determination. When only one or none of the comparators 48 and 64 indicates that a received signal is present, the AND circuit 66 does not indicate that there is a received signal present.

In another aspect, the output of the slope detector 62 may be compared with the threshold signal m_{TH} in the comparator 64, and used to indicate the presence of a received signal without having an integrated output above some specific signal level TH₁. That is, the presence of the signal indication depends only on the output of the comparator 64 and the AND circuit 66 may be omitted.

The apparatus and method disclosed herein improves the determination of the presence or absence of a signal at a receiver input by combining the determination of the integrated value of a demodulator output and the slope of the output of the integrated demodulator output.

Although the present invention has been explained by way of the examples described above, it should be understood to the ordinary skilled person in the art that the invention is not limited to the examples, but rather that various changes or modifications thereof are possible without departing from the spirit of the invention. Accordingly, the scope of the invention shall be determined only by the appended claims and their equivalents.

What is claimed is:

1. A signal receiver, comprising:
an integrator;
a slope determination circuit connected to an output of the integrator; and,
a first input of a first comparator connected to an output of the slope determination circuit,
wherein a slope threshold value is connected to a second input of the first comparator, and the slope threshold value is determined such that an output of the first comparator is a first detection value when the output value of the slope determination circuit is greater than or equal to the slope threshold value.

2. The signal receiver of claim 1, further comprising a second comparator, a first input of the second comparator being connected to the output of the integrator, and outputs of the first and second comparators being connected to an AND gate, wherein a signal threshold value is connected to a second input of the second comparator, and the signal threshold value is determined such that an output value of the second comparator is a second detection value when the output of the integrator is greater than the signal threshold value, and the output of the AND gate is a third detection value when the first and the second detection values are present simultaneously.

3. The signal receiver of claim 1, further comprising a demodulator including a correlator, and an integrate-and-dump circuit communicating with an output of the correlator, wherein an output value of the integrate-and-dump circuit is periodically set to zero at first fixed intervals.

4. The signal receiver of claim 1, wherein the output of the integrator is periodically set to zero at second fixed intervals.

5. The signal receiver of claim 1, further comprising a downconverter.

6. The signal receiver of claim 5, wherein one of the downconverter or the demodulator further comprises a multiplier, and a first input to the multiplier is a received signal and a second input to the multiplier is a pseudo-random-noise (PRN) sequence having a fixed time of repetition.

7. The signal receiver according to claim 3, wherein the first fixed time is a first multiple of a pseudo-random-noise (PRN) fixed time and the first multiple is greater than or equal to unity.

8. The signal receiver according to claim 7, wherein the second fixed time is a second multiple of the first fixed time, and the second multiple is greater than or equal to unity.

9. A signal receiver, comprising:
in-phase and quadrature demodulation circuits each having an integrate-and-dump circuit in communication with outputs of the in-phase and quadrature demodulators, respectively, each integrate-and dump-circuit having a first integration time greater than or equal to a pseudo-random-code (PRN) repetition period;
a magnitude converter, connected to outputs of the integrate-and-dump circuits, outputting a magnitude value using the outputs of the integrate-and-dump circuits;
an integrator connected to an output of the magnitude converter, the integrator having a second integration time greater than the first integration time;
a slope computing circuit connected to an output of the integrator; and
a first comparator having a first input connected to an output of the slope computing circuit and a second input connected to a slope threshold value.

10. The receiver of claim 9, further comprising a second comparator having a first input connected to the output of the integrator, and a second input connected to a signal threshold value, wherein a signal detected indication is output when the output of both the slope computing circuit exceeds the slope threshold value and the output of the integrator exceeds the signal threshold value simultaneously.

11. The signal receiver according to claim 9, wherein the slope threshold value is determined such that the slope computing circuit output value exceeds the slope threshold value when a signal is present.

12. A method of detecting the presence of a signal, the method comprising:
repetitively integrating an input signal in a first integrator for a first time period and outputting the integrated result to a second integrator;
integrating the first integrator output in the second integrator for a second time period, the second time period being longer than the first time period;
processing an output of the second integrator during the second time period to determine a slope of the second integrator output; and
comparing the slope with a first threshold value.

13. The method of claim 12, further comprising outputting a first detection signal when the slope is greater than or equal to the first threshold value.

14. The method of claim 13, further comprising:
comparing the second integrator output with a second threshold value; and
outputting a second detection signal when the slope is greater than or equal to the first threshold value, and the second integrator output is greater than or equal to the second threshold value.

15. The method of claim 12, wherein the output of the first integrator is periodically set to zero at a first time interval equal to the first time period, and the output of the second integrator is periodically set to zero at a second time interval equal to the second time period.

16. The method of claim 15, wherein the first time period is a multiple, greater than or equal to unity, of a pseudo-random-noise (PRN) code repetition time, and the second time period is a multiple, greater than or equal to unity, of the first time period.
